(19) United States
(12) Patent Application Publication
(10) Pub. No.: US 2010/0123969 A1
(43) Pub. Date: May 20, 2010

(54) INFORMATION STORAGE DEVICE AND CONTROL CIRCUIT

(75) Inventor: Yukio Urata, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/570,692

(22) Filed: Sep. 30, 2009

(30) Foreign Application Priority Data
Nov. 14, 2008 (JP) 2008-292533

(51) Int. Cl. G11B 21/02

(52) U.S. Cl. 360/75; G9B/21.003

(57) ABSTRACT

According to one embodiment, an information storage device includes: a head reading user data and a start tag indicating a recording start position of the user data in each sector recorded on a medium, the user data and the start tag being read in order of the start tag and the user data; and a controller controlling the head to read a start tag recorded in a preceding sector arranged at a position to be read before a target sector with a movement of the medium, acquiring information on a recording start position of a user data recorded in the target sector based on the start tag read by the head and a relative positional relation between the preceding sector and the target sector, and controlling the head to read the user data recorded in the target sector.

### CROSS-REFERENCE TO RELATED APPLICATIONS

This application is based upon and claims the benefit of priority from Japanese Patent Application No. 2008-292533, filed Nov. 14, 2008, the entire contents of which are incorporated herein by reference.

### BACKGROUND

1. Field

One embodiment of the invention relates to an information storage device and a control circuit.

2. Description of the Related Art

An information storage device represented by a hard disk drive (HDD) is mounted on an electronic device represented by not only a computer but also a video recorder as a large-capacity storage device capable of high-speed access and high-speed transfer of data.

A magnetic disk drive has a disc-like magnetic disk that magnetically stores information, a magnetic head that performs writing and reading of data with respect to a magnetic disk, and a control circuit.

A plurality of tracks are provided on a magnetic disk in a concentric circular shape, and each of the tracks is divided into a plurality of sectors. The magnetic head relatively moves on the tracks with rotations of the magnetic disk, and performs writing and reading of data with respect to a target sector. A preamble, a sync mark, and user data are recorded in each sector of the magnetic disk to be read in this order. The preamble is data, which becomes a reference of synchronization of a clock to read the data, and expresses a single pattern common to all sectors. The sync mark finds a head of user data, and expresses a single pattern common to all sectors. The control circuit of the magnetic disk drive synchronizes a clock for reading with a pattern of a preamble read by the magnetic head, and when the sync mark is read, causes the magnetic head to read the user data, assuming that the user data follows the sync mark.

FIG. 1 is a schematic diagram of data read from a sector.

The control circuit of the magnetic disk drive synchronizes a clock for reading with a pattern of a preamble 301 read from a sector, according to a read gate signal RG expressing that a sector to be read approaches the magnetic head. The control circuit then detects a sync mark 302 to acquire user data 303. The read gate signal RG is generated based on servo patterns scattered on the tracks, and does not synchronize with a reading timing of data with accuracy of clock level.

FIG. 2 is a schematic diagram for explaining a state where an error is included in user data among data read from a sector, and FIG. 3 is a schematic diagram for explaining a state where an error is included in a sync mark.

For example, there may be an error in the read user data 303 due to dust or scratch on a magnetic disk. The user data 303 includes error correcting code (ECC) data for error correction, and, as illustrated in FIG. 2, even if there is an error in a part of the user data 303, data with the error can be recovered as correct data by error correction, as far as the error amount is within a certain range. However, as illustrated in FIG. 3, if there is an error in a sync mark 203, a reading timing of the user data 303 cannot be acquired, and thus the user data cannot be read.

As one of countermeasures for errors in a sync mark, a technique referred to as a dual sync mark has been known. It is a technique in which two sync marks are arranged in each sector. According to this dual sync mark, when a sync mark to be read first in a sector to be read cannot be recognized due to an error, the user data is read based on a sync mark to be read later. The user data between two sync marks is recovered by the ECC.

As another countermeasure, there has been known a technique, in which even if some of bits constituting a sync mark are abnormal, these are regarded as a sync mark. In this case, even if a part of bits of the sync mark includes an error, there is a possibility that user data can be read.

As still another countermeasure, a technique referred to as force sync mark (Force SM) has been known, in which reading of user data is attempted after waiting for a predetermined delay time since a timing of the read gate signal RG.

Further, although not relating to the sync mark, a processing method of a recording medium has been known. In this method, with regard to a recording medium on which a serial number is recorded as ID data for each of usable sectors, if the ID data can be read in both sectors arranged before and after a sector, the sector therebetween is used as a usable sector (for example, see Japanese Patent Application Publication (KOKAI) No. 2000-173199).

However, in the dual sync mark, the amount of user data recorded between two sync marks is limited to a range recoverable by FCC correction. Therefore, when a recording density is increased, a physical distance between the two sync marks on a magnetic disk becomes short, and both of the sync marks may not be read due to mere dust or scratch.

In the technique in which bits are regarded as a sync mark even if some of them are abnormal, data that is not originally a sync mark may be regarded as a sync mark. As an allowable range of abnormal bits increases, user data may not be read correctly.

In the force sync mark, because a jitter included in a timing of a read gate signal is larger with respect to a reading timing of user data, a probability of correctly reading the user data is low.

FIG. 4 is a schematic diagram for explaining an arrangement of data written in a sector on a magnetic disk, and FIG. 5 is a schematic diagram for explaining reading of data written on a magnetic disk.

A magnetic head 310 illustrated in FIG. 4 writes a preamble 311, a sync mark 312, and user data 313 in a sector to be written, while being matched with a timing of a write gate signal WG. The write gate signal WG is generated based on a servo pattern recorded at a position away from the sector to be written, thereby the write gate signal WG has a jitter resulting from rotation nonuniformity or the like. That is, a jitter occurs at a position where the data is written for every writing, from a viewpoint of clock accuracy. The same applies to a case of reading illustrated in FIG. 5, and the read gate signal RG also has a jitter. Therefore, it is difficult to read a sync mark 322 and user data 323 at an accurate timing by the force sync mark, and thus utilization of the force sync mark is not practical.

Further, in the method in which a sector between two sectors from which ID data is read is regarded as a usable sector, there are cases that the ID data cannot be read, and when a sync mark cannot be detected, it cannot handle a situation where user data cannot be read.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of data read from a sector;

FIG. 2 is an exemplary schematic diagram for explaining a state where an error is included in user data among data read from a sector;

FIG. 3 is an exemplary schematic diagram for explaining a state where an error is included in a sync mark among data read from a sector;

FIG. 4 is an exemplary schematic diagram for explaining a data timing and an arrangement of data written in a sector on a magnetic disk;

FIG. 5 is an exemplary schematic diagram for explaining reading of data written on a magnetic disk;

FIG. 6 is an exemplary block diagram of an HDD, which is a magnetic disk drive according to a first embodiment of the invention;

FIG. 7 is an exemplary schematic diagram of a format of data recorded on a track of a magnetic disk in the first embodiment;

FIG. 8 is an exemplary block diagram of relevant parts of data conversion in a frame converter and a code converter in the first embodiment;

FIG. 9 is an exemplary timing chart illustrating write data output from a read channel in the first embodiment;

FIG. 10 is an exemplary schematic diagram for explaining data reading in a tag diversion mode in the first embodiment;

FIG. 11 is an exemplary flowchart of a reading process in the first embodiment;

FIG. 12 is an exemplary flowchart of a reading process according to a second embodiment of the invention; and

FIG. 13 is an exemplary flowchart of a reading process according to a third embodiment of the invention.

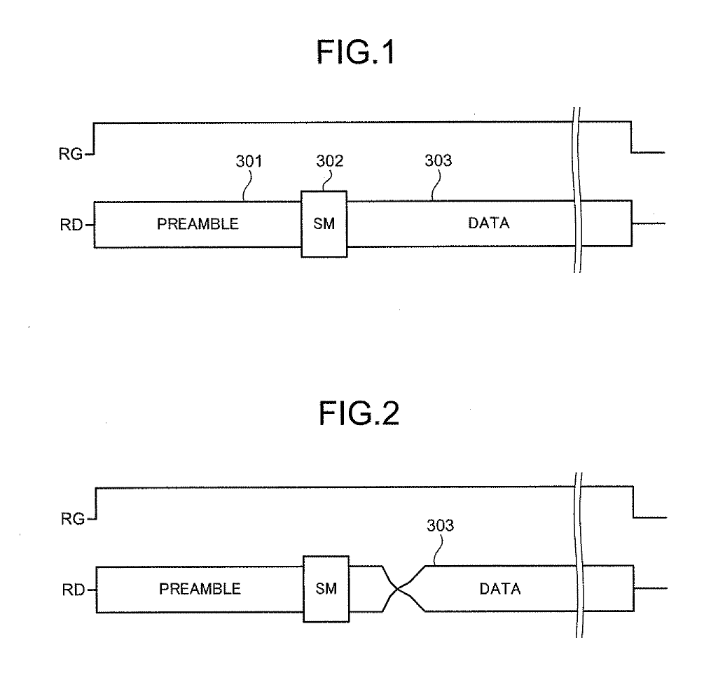

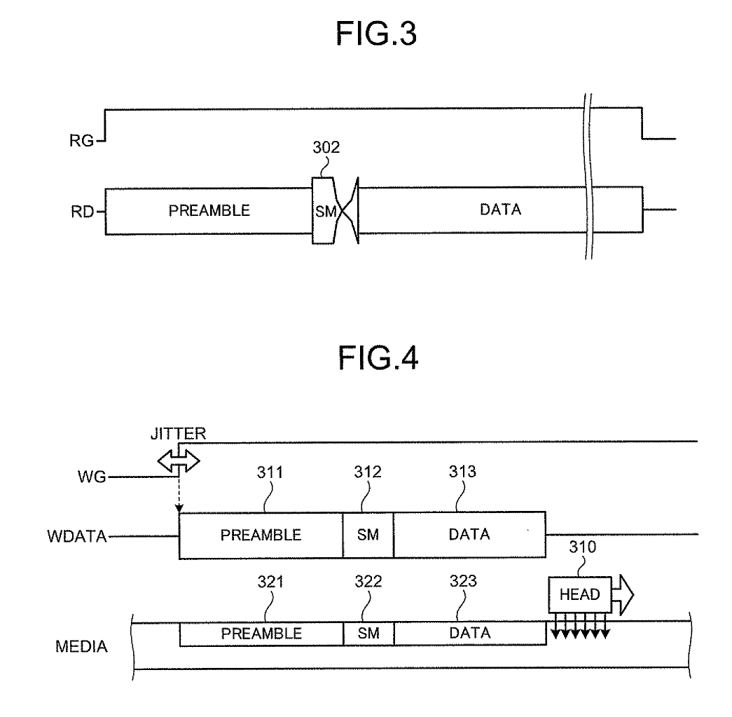

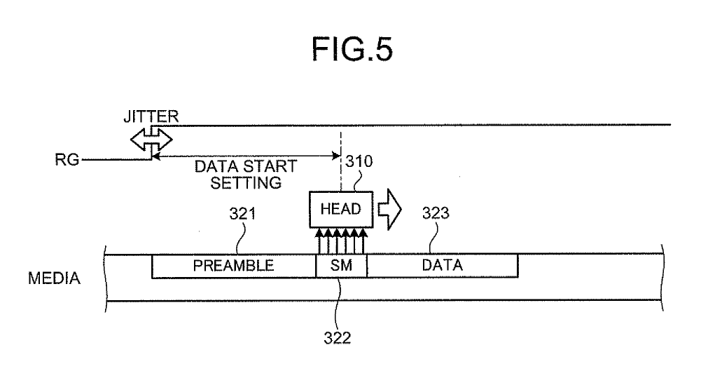

### DETAILED DESCRIPTION

Various embodiments according to the invention will be described hereinafter with reference to the accompanying drawings. In general, according to one embodiment of the invention, an information storage device, includes: a head configured to read user data and a start tag indicating a recording start position of the user data in each sector recorded on a medium, the user data and the start tag being read in order of the start tag and the user data while the head relatively moving on a track of the medium; and a controller configured to control the head to read a start tag recorded in a preceding sector arranged at a position to be read before a target sector with a movement of the medium, acquire information on a recording start position of a user data recorded in the target sector based on the start tag read by the head and a relative positional relation between the preceding sector and the target sector, and control the head to read the user data recorded in the target sector.

According to another embodiment of the invention, a control circuit of an information storage device including a head configured to read user data and a start tag indicating a recording start position of the user data in each sector recorded on a medium, the user data and the start tag being read in order of the start tag and the user data while the head relatively moving on a track of the medium, includes a controller configured to control the head to read a start tag recorded in a preceding sector arranged at a position to be read before a target sector with a movement of the medium, acquire information on a recording start position of a user data recorded in the target sector based on the start tag read by the head and a relative positional relation between the preceding sector and the target sector, and control the head to read the user data recorded in the target sector.

Specific embodiments of an information storage device and a control circuit according to the invention are explained below.

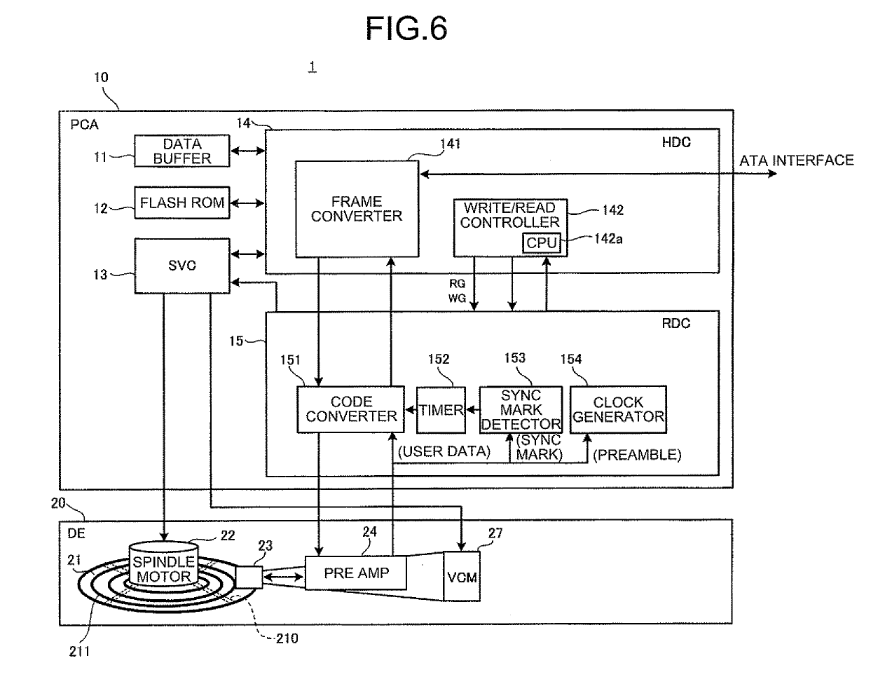

FIG. 6 is an exemplary block diagram of a hard disk drive (HDD) as a magnetic disk drive according to a specific first embodiment of the invention.

An HDD 1 illustrated in FIG. 6 has a control circuit 10 and a disk enclosure (DE) 20. The disk enclosure 20 has a magnetic disk 21, a spindle motor 22, a magnetic head 23, a preamplifier (Pre Amp) 24, and a voice coil motor (VCM) 27.

The magnetic disk 21 is driven to rotate by the spindle motor 22. The magnetic disk 21 is provided with circular tracks 211 centering on an axis of rotation, and data is recorded on the tracks 211. The magnetic head 23 performs writing and reading of data with respect to the magnetic disk 21, while relatively moving on the tracks 211 with rotations of the magnetic disk 21. The preamplifier 24 amplifies a signal supplied to the magnetic head 23 and a signal output from the magnetic head 23. The VCM 27 moves the magnetic head 23 in a radial direction of the magnetic disk 21.

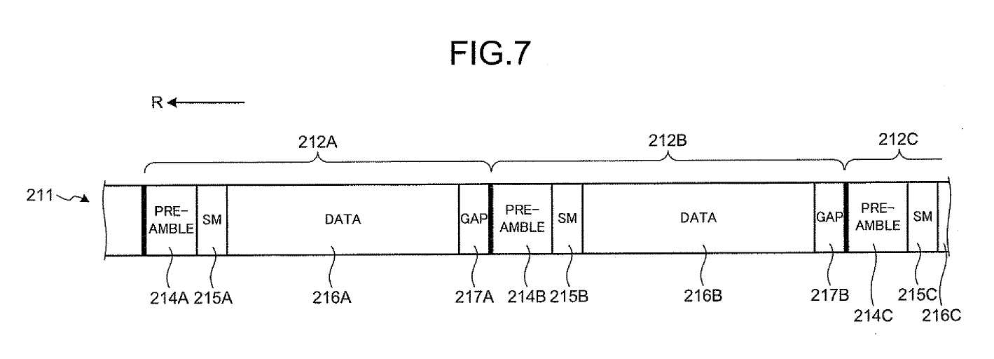

FIG. 7 is an exemplary diagram of a format of data recorded on a track of the magnetic disk.

A plurality of sectors 212 (212A, 212B, 212C, . . . ) are sequentially arranged on the tracks 211, and data is recorded per unit sector 212. Each of the sectors 212 records a preamble 214 (214A, 214B, 214C, . . . ), a sync mark 215 (215A, 215B, 215C, . . . ) and user data 216 (216A, 216B, 216C, . . . ). The magnetic head 23 (see FIG. 6) relatively moves in a direction opposite to an arrow R, with a movement of the tracks 211 in a direction illustrated by the arrow R due to rotations of the magnetic disk 21. That is, data is recorded in each of the sectors 212 in order of reading of the preamble 214, the sync mark 215, and the user data 216 by the magnetic head 23. A gap area 217 in which effective data is not recorded is provided next to the user data 216.

The preamble 214 is data, which becomes a reference of synchronizing a clock for reading the data from the sector 212, and has a pattern common to all sectors. The sync mark 215 indicates a recording start position of the user data 216. More specifically, the sync mark 215 indicates that the user data 216 is read immediately after the sync mark 215. The sync mark 215 also has a pattern common to all sectors. The user data 216 is received data sent from a host (not illustrated) to which the HDD 1 is externally connected. Received data from the host is recorded as user data in one sector 212 per 512 bytes. As the user data 216, the data from the host is converted and recorded in a state including data of cyclic redundancy check (CRC) and ECC. The sync mark 215 corresponds to an example of a start tag in the basic mode described above.

The explanation is continued with referring back to FIG. 6.

The control circuit 10 has a data buffer 11, a flash read only memory (flash ROM) 12, a servo controller (SVC) 13, a hard disk controller (HDC) 14, and a read channel (RDC) 15.

The hard disk controller 14 and the RDC 15 in the control circuit 10 cause the magnetic head 23 to perform writing and reading of data with respect to a target sector. The hard disk controller 14 and the RDC 15 cause the magnetic head 23 to select one of reading modes of a normal mode and a tag diversion mode to read user data, at the time of reading the user data from a target sector. For example, when it is assumed that the sector indicated by reference character 212B in FIG. 7 is a target sector 212B in which user data 216B to be read is recorded, in the normal mode, the hard disk controller 14 and the RDC 15 cause the magnetic head 23 to read the sync mark 215B recorded in the target sector 212B to acquire information of the recording start position of the user data 216B based on the sync mark 215B, and read the user data 216B. The information on the recording start position of the user data 216B is a timing at which the reading of the sync mark 215B is completed. Therefore, the hard disk controller 14 and the RDC 15 cause the magnetic head 23 to read the user data 216B following reading of the sync mark 215B. On the other hand, in the tag diversion mode, the hard disk controller 14 and the RDC 15 cause the magnetic head 23 not to read the target sector 212B first, but to read the sync mark 215A recorded in a preceding sector 212A arranged at a position to be read before the target sector 212B. The hard disk controller 14 and the RDC 15 then acquire the information of the recording start position of the user data 216B to be read, which is recorded in the target sector, based on a relative positional relationship between the preceding sector 212A and the target sector 212B, and cause the magnetic head 23 to read the user data 216B. Details of reading in the normal mode and the tag diversion mode will be described later. A combination of the hard disk controller 14 and the RDC 15 corresponds to an example of a controller in the basic mode described above.

The hard disk controller 14 has a frame converter 141 and a write/read controller 142. The frame converter 141 converts received data from the host connected to the HDD 1 and converts data to be output to the host. The write/read controller 142 performs overall control of the HDD 1, and causes the magnetic head 23 to perform writing and reading of data with respect to the target sector of the magnetic disk 21. The write/read controller 142 generates the read gate signal RG and the write gate signal WG expressing that the magnetic head 23 has reached the target sector of the magnetic disk 21. It is determined based on servo information read from a servo pattern 210 of the magnetic disk 21 that the magnetic head 23 has reached the target sector of the magnetic disk 21. The servo information is supplied via the RDC 15. The write/read controller 142 has a central processing unit (CPU) 142a and performs a control process by executing a program.

The data buffer 11 is a memory that temporarily stores data of a host computer and the like, and the flash ROM 12 is a memory that stores programs to be executed by the hard disk controller 14 as well as various parameters.

The servo controller 13 controls the spindle motor 22 to maintain the number of revolutions of the magnetic disk 21, and controls the VCM 27 to move the magnetic head 23 to the tracks 211 to be read.

The RDC 15 performs conversion of signals transferred between the hard disk controller 14 and the magnetic head 23. The RDC 15 has a code converter 151, a timer 152, a sync mark detector 153, and a clock generator 154.

The clock generator 154 generates a clock. Data is output to the magnetic head 23 and a signal supplied from the magnetic head 23 is loaded, in synchronization with the clock. When data is read, the clock generator 154 generates a clock in synchronization with a preamble signal read from the magnetic head 23. The generated clock is supplied to the code converter 151, the timer 152, and the sync mark detector 153. By using the synchronized clock, the code converter 151 and the sync mark detector 153 can read the data at an appropriate clock timing.

The sync mark detector 153 detects a sync mark from a signal of data read by the magnetic head 23.

The timer 152 performs timing of a delay time set by the write/read controller 142 from the time when the sync mark detector 153 detects the sync mark, that is, the time when data reading of the sync mark by the magnetic head 23 is completed. Then, the timer 152 informs the code converter 151 of a reading timing at the timing when the delay time is passed. The timer 152 is, more specifically, a counter that counts the clock output from the clock generator 154. In the normal mode, 0 is set for the delay time by the write/read controller 142, and in this case, the timer 152 does not substantially perform any timing, but informs the code converter 151 of a reading timing at the timing when the sync mark detector 153 detects the sync mark.

The code converter 151 converts the data supplied from the frame converter 141 into a code, and outputs the code to the magnetic head 23. The code converter 151 performs a conversion reverse to the case of writing with respect to the signal of data read from the magnetic head 23, to supply the signal to the frame converter 141.

The data written in each sector illustrated in FIG. 7 is acquired by converting the received data from a host by the HDC 14 and the RDC 15, and writing the data by the magnetic head 23.

Before explaining data reading, data conversion performed by the frame converter 141 in the HDC 14 and the code converter 151 in the RDC 15 is explained. Also, how data is written in a sector is explained.

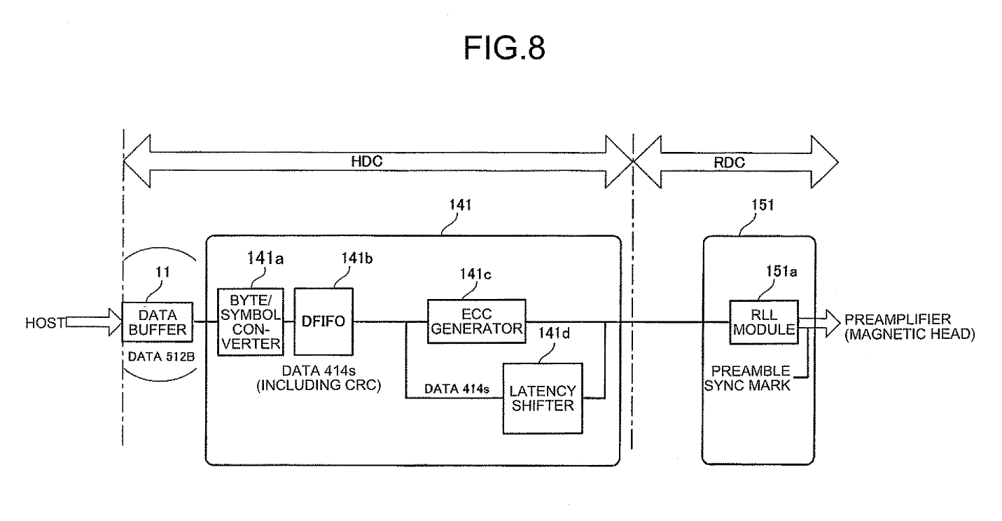

FIG. 8 is an exemplary block diagram of relevant parts of data conversion in the frame converter 141 and the code converter 151.

The frame converter 141 reads and processes data sent from a host and temporarily stored in the data buffer 11 per 512 bytes. When the data from the host stored in the data buffer 11 exceeds 512 bytes, the frame converter 141 sequentially reads and processes the data per 512 bytes so that the data can be written in adjacent sectors continuously.

The frame converter 141 has a byte/symbol converter 141a, a data first in first out (DFIFO) 141b, an ECC generator 141c, and a latency shifter 141d. Further, the code converter 151 in the RDC 15 has a run length limited (RLL) module 151a.

The byte/symbol converter 141a converts a data unit from byte to symbol. 1 byte is 8 bits and 1 symbol is 10 bits. More specifically, the byte/symbol converter 141a converts 516-byte data in which 512-byte data is added with 4-byte CRC data to the symbol by 16/20 conversion. The 516-byte data is converted to 412.8 (516×16÷20=412.8) symbols. The DFIFO 141b stores the symbol data converted by the byte/symbol converter 141a once, and supplies the stored symbol data to an ECC generator 142c and the latency shifter 141d. The DFIFO 141b adds 1.2-symbol data to the 412.8-symbol data for convenience of ECC processing to make 414-symbol data. Continuation identifying information is included in the data to be added. The continuation identifying information expresses that data is continuously recorded in over a target sector and a sector arranged at a position to be read next. When unprocessed data remains in the data buffer 11 even after the byte/symbol converter 141a has read data for one sector from the data buffer 11, the continuation identifying information is inserted therein.

The ECC generator 141c generates, for example, 32-symbol ECC data based on the symbol data acquired from the DFIFO 141b. The latency shifter 141d delays symbol data acquired from the DFIFO 141b.

The RLL module 151a corrects data so that periodic waves are included in a waveform to prevent that the waveform expressing the data becomes linear. The RLL module 151a executes 60/30 conversion with respect to 446-symbol data acquired by adding 32-symbol data generated by the ECC generator 141c to the 414-symbol data output from the latency shifter 141d. The RLL module 151a adds a preamble and a sync mark to the 60/30 converted data, thereby completing the data to be written in one sector. The data is supplied to the magnetic head 23 via the preamplifier (see FIG. 6). The frame converter 141 and the code converter 151 execute a process reverse to the process described above, at the time of reading data.

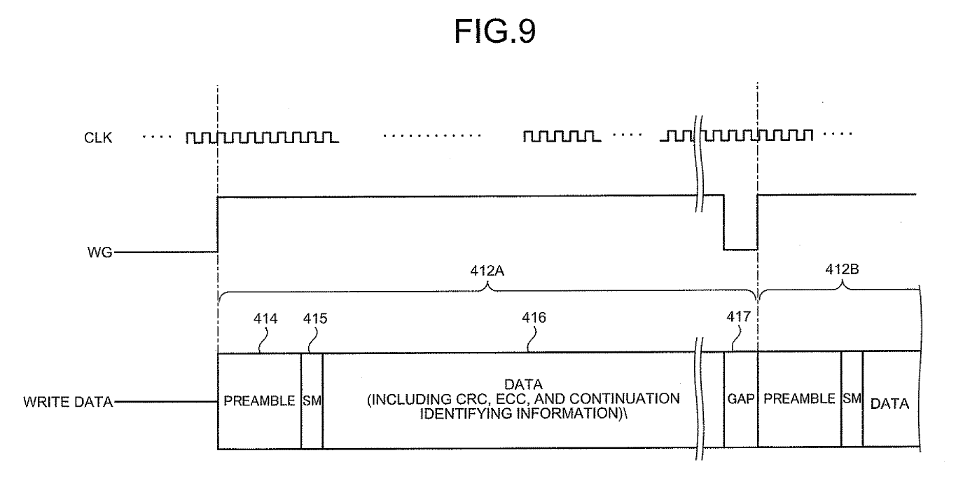

FIG. 9 is an exemplary timing chart illustrating write data output from the RDC 15.

The RDC 15 outputs the data completed in the RLL module 151a (see FIG. 8), in synchronization with a clock CLK generated by the clock generator 154. The data is output in order of a preamble 414, a sync mark 415, and user data 416, and lastly, a fixed value is output corresponding to a GAP 417 for a certain period of time.

When the data sent from a host is larger than 512 bytes and is written in a plurality of sectors, writing of data is continuously performed over the adjacent sectors. For example, there is little chance for the host to handle data less than 512 bytes not only for image data and music data but also document data, and thus the data is generally written over a plurality of sectors. For example, when data is written in two adjacent sectors, the RDC 15 outputs data 412B of a second sector following data 412A of a first sector. In this case, data is written in over two adjacent sectors in synchronization with the continuous clock CLK. Thus, there is established a state that data is written in the sectors 212A and 212B in the arrangement illustrated in FIG. 7.

When data is written continuously in two adjacent sectors, the user data 416 of the data 412A of the first sector written first includes continuation identifying information. On the other hand, the user data 416 of the data 412B of the second sector written later does not include the continuation identifying information. Accordingly, the continuation identifying information indicating that the data is continuously recorded in over the sector 212A and the sector 212B arranged at a position to be read following the sector 212A with rotations of the magnetic disk 21 is recorded in the sector 212A illustrated in FIG. 7.

Next, data reading is explained while assuming that, as an example, data is read from the sector 212B illustrated in FIG. 7.

When data is read in a normal mode, the RDC 15 receives the read gate signal RG indicating that the magnetic head 23 has reached the sector 212B to be read, from the hard disk controller 14. The clock generator 154 in the RDC 15 generates a clock in synchronization with the pattern of the preamble 214B read by the magnetic head 23, in response to the read gate signal.

Next, when the magnetic head 23 reads the sync mark 215B, the sync mark detector 153 detects the pattern of the sync mark from the output signal from the magnetic head 23.

The timer 152 performs timing of a delay time set from a timing at which the sync mark detector 153 detects the sync mark, and informs the code converter 151 of a timing for the reading when the delay time is passed. In the normal mode, the delay time is set to 0, so that the timing for the reading is informed to the code converter 151 at the timing when the sync mark detector 153 detects the sync mark. That is, in the normal mode, the timing for the reading is acquired as the information on the recording start position of the user data 216B, based on the sync mark 215B.

The code converter 151 loads the user data 216B read by the magnetic head 23 to convert the data at the timing for the reading informed by the timer 152, that is, at the timing when the sync mark detector 153 detects the sync mark.

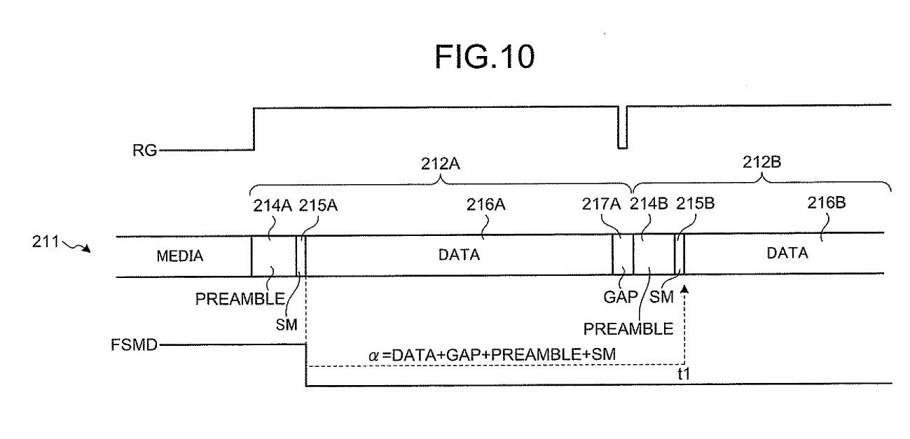

FIG. 10 is an exemplary schematic diagram for explaining data reading in a tag diversion mode.

In the tag diversion mode, the preamble 214A and the sync mark 215A recorded in the preceding sector 212A arranged at a position where reading is performed immediately before the target sector 212B are read by the magnetic head 23. More specifically, the write/read controller 142 outputs the read gate signal RG at the timing when the magnetic head reaches not the target sector 212B but the preceding sector 212A. Further, a delay time α indicating a relative positional relationship between the preceding sector 212A and the target sector 212B is set to the timer 152 by the write/read controller 142. More specifically, the delay time α is the number of clocks calculated as the time required for the magnetic head 23 to pass the user data 216A, the GAP 217A, the preamble 214B, and the SM 215B. The delay time α is equal to the time required for the magnetic head 23 to pass one sector 212A, and is different for each track. The flash ROM 12 stores the delay time calculated beforehand for each track, and the write/read controller 142 reads the delay time corresponding to the track to which the sector to be read belongs and sets the delay time to the timer 152. The delay time can include correction such as delay acquired by detection by the sync mark detector 153.

The RDC 15 receives the read gate signal RG indicating that the magnetic head 23 has reached the preceding sector 212A from the hard disk controller 14. The clock generator 154 in the RDC 15 generates the clock in synchronization with the pattern of the preamble 214A read by the magnetic head 23 in response to the read gate signal RG. When the magnetic head 23 reads the sync mark 215A, the sync mark detector 153 detects the sync mark from the output signal from the magnetic head 23, and outputs a detection signal FSMD.

The timer 152 informs the code converter 151 of the timing for reading at the time t1 when the delay time α is passed from the timing when the sync mark detector 153 detects the sync mark. This timing indicates a timing when the magnetic head 23 has reached the recording position of the user data 216B of the target sector 212B following the preceding sector 212A, with respect to the code converter 151. That is, the timing for reading, which is information on the recording start position of the user data 216B recorded in the target sector 212B, is acquired based on the sync mark 215A and a relative positional relationship between the preceding sector 212A and the target sector 212B.

The code converter 151 loads the user data read by the magnetic head 23 at the informed timing for reading, thereby reading the user data 216B accurately from the target sector 212B.

In the tag diversion mode, because the user data 216B can be read without reading the sync mark 215B of the target sector 212B, the user data 216B can be read even when the sync mark 215B of the target sector 212B cannot be read.

A process in which reading is performed by switching the normal mode and the tag diversion mode is explained next.

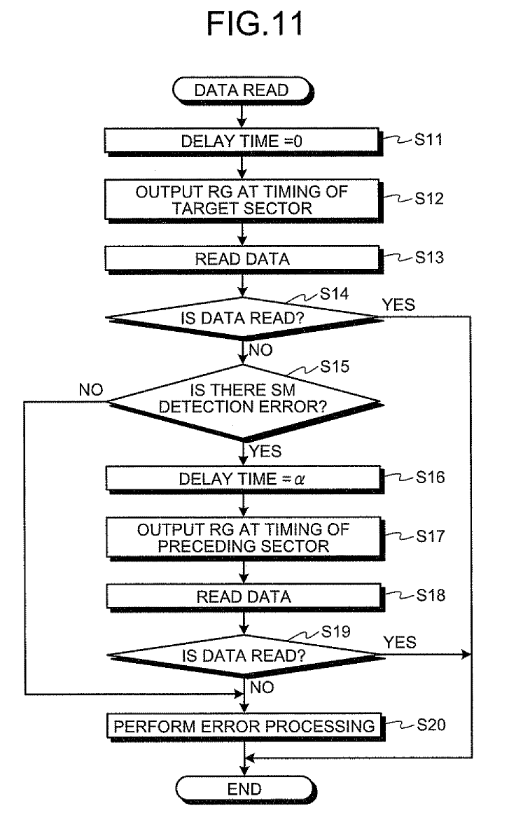

FIG. 11 is an exemplary flowchart of a reading process.

The write/read controller 142 first attempts to read in the normal mode. Specifically, the write/read controller 142 sets 0 to the timer 152 as the delay time (S11), outputs the read gate signal RG at the timing of the sector to be read (212B in FIG. 10) (S12), to read the user data (S13). At S13, when the target sector 212B reaches the magnetic head 23, the read gate signal RG is output, and the sync mark 215B of the target sector 212B is detected by the sync mark detector 153, the user data 216B is read following the sync mark 215B (YES at S14).

On the other hand, when the user data 216B is not read within a predetermined limited time (NO at S14), and when an error other than an error such that the sync mark of the target sector cannot be read is not detected (NO at S15), the write/read controller 142 determines that reading of the sync mark 215B cannot be performed, and performs a recovery process to read the data again. In the recovery process, the write/read controller 142 switches the reading mode to the tag diversion mode, to attempt to read the data. Specifically, the write/read controller 142 sets the delay time α corresponding to the target track to the timer 152 as the delay time (S16), and outputs the read gate signal RG at the timing of the preceding sector 212A instead of the target sector 212B (S17), to read the user data (S18).

In the tag diversion mode, when the preceding sector 212A reaches the magnetic head, the read gate signal RG is output, and the sync mark 215A of the preceding sector 212A is detected by the sync mark detector 153, the user data 216B is read from the target sector 212B at the delay time α timed by the timer 152 since the detection timing thereof (YES at S19).

When the user data is not read even in the tag diversion mode (NO at S19), it is regarded that the user data cannot be read due to some reason such as the sync mark of the preceding data being not accurately recorded, and error processing is performed (S20). In the error processing, error information indicating that reading cannot be performed is transmitted to a host, and a reassigning process in which the target sector is handled as an invalid sector is performed. Prior to the error processing (S20), a recovery process can be performed by another method such as changing a supply current to a magnet head.

In the tag diversion mode, even if the sync mark 215B cannot be read from the target sector 212B, the user data 216B can be read. When the sync mark 215B can be read from the target sector 212B, because the user data 216B is read by the synchronized clock based on the preamble 214B stored in the target sector 212B by reading the data in the normal mode, the user data 216B is read at a more accurate clock timing. Therefore, by switching the reading mode, data read is performed at a more accurate timing in the normal mode, and possibility of data reading in the tag diversion mode can be increased.

In other words, when the magnetic head cannot read the start tag of the target sector, it is preferred that the controller switches the reading mode from the normal mode to the tag diversion mode.

In the embodiment described above, by designating a sector arranged at a position to be read immediately before the target sector as the preceding sector, deviation of the clock accumulated since detection of a sync mark in the preceding sector to the start of reading of the user data of the target sector can be suppressed, as compared with a case that a sector to be read two or more sectors before the target sector is designated as a preceding sector.

In other words, it is preferred that the controller designates a sector arranged at a position to be read immediately before the target sector with rotations of the disk as the preceding sector.

A magnetic disk drive and a control circuit according to a specific second embodiment of the invention are explained next. The second embodiment is different from the first embodiment in a part of the data reading process, and the second embodiment is the same as the first embodiment in other parts of the data reading process and block configurations. In explanations of the second embodiment, processes identical to those of the first embodiment are denoted by like reference characters, and features different from those of the first embodiment are explained. In addition, as for block configurations and data arrangements of the second embodiment, explanations thereof are made with reference to the drawings explained above.

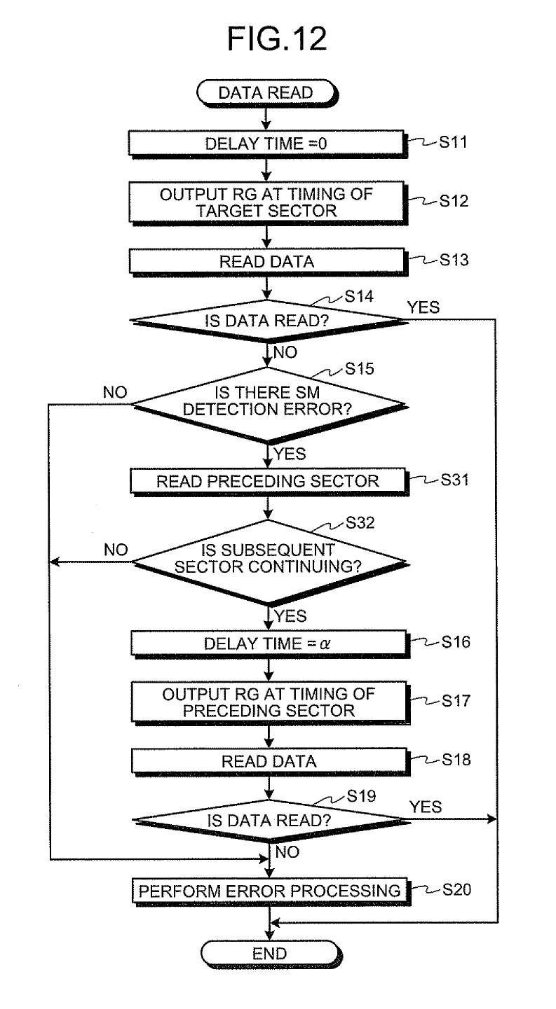

FIG. 12 is an exemplary flowchart of a reading process in the second embodiment.

In the reading process illustrated in FIG. 12, when the write/read controller 142 (see FIG. 6) determines that the sync mark 215B cannot be read from the target sector 212B (see FIG. 10) (NO at S15), data is read from the preceding sector 212A in a normal mode (S31), before switching a reading mode to a tag diversion mode (S16). It is then determined whether data has been written in the target sector 212B, which is a subsequent sector of the preceding sector 212A, continuously to the preceding sector 212A (S32). This determination is made according to whether continuation identifying information recorded in the preceding sector 212A has been read. More specifically, this determination is made according to whether continuation identifying information is included in the user data 216A read from the preceding sector 212A at S31. When continuation identifying information is included in the user data 216A of the preceding sector 212A (YES at S15), the write/read controller 142 switches the reading mode to the tag diversion mode in the process at S16 and thereafter, to read the user data 216B of the target sector 212B.

On the other hand, when continuation identifying information is not included in the user data 216A of the preceding sector 212A (NO at S15), data is not written continuously in the preceding sector 212A and the target sector 212B. In this case, a timing of a clock at which the data is written is discontinuous between the preceding sector 212A and the target sector 212B, and there is little possibility that data can be read in the tag diversion mode. In this case, the write/read controller 142 does not perform reading in the tag diversion mode (S16 to S19), and performs the recovery process and the error processing (S20) according to other methods.

When the continuation identifying information is read from the preceding sector 212A as described above, reading in the tag diversion mode can be performed in a case of having high possibility of reading by switching the reading mode to the tag diversion mode.

In other words, it is preferred that each sector arranged on the magnetic disk records the continuation identifying information indicating that the data is recorded continuously in over the sector and a sector arranged at a position to be read next to the sector with rotations of the magnetic disk, and when the continuation identifying information is recorded in the preceding sector, it is preferred that the controller causes the magnetic head to read the user data in the tag diversion mode.

A magnetic disk drive and a control circuit according to a specific third embodiment of the invention is explained next. The third embodiment is different from the second embodiment in that overwrite of data and a verifying process are added to the configuration of the second embodiment, and the third embodiment is the same as the second embodiment in a part of data reading and block configurations. In explanations of the third embodiment, processes identical to those of the second embodiment are denoted by like reference characters, and features different from those of the second embodiment are explained. In addition, as for block configurations and data arrangements of the third embodiment, explanations thereof are made with reference to the drawings explained above.

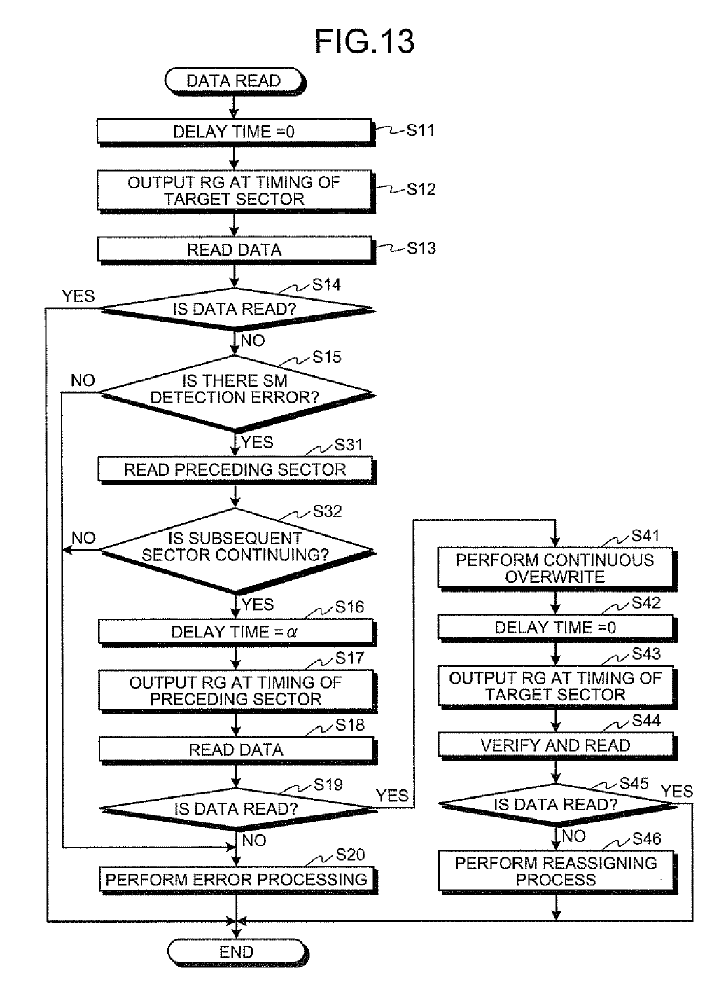

FIG. 13 is an exemplary flowchart of a reading process in the third embodiment.

In the reading process illustrated in FIG. 13, when the user data 216B is read from the target sector 212B (see FIG. 10) in a tag diversion mode (YES at S19), the write/read controller 142 (see FIG. 6) causes the magnetic head 23 to overwrite data in the preceding sector 212A and the target sector 212B continuously (S41). At this step, the write/read controller 142 (see FIG. 6) causes the magnetic head 23 to write the data read from the preceding sector 212A at S31 in the preceding sector 212A, and subsequently, causes the magnetic head 23 to write data read from the target sector 212B at S18 in the target sector 212B. At this time, in the same manner as in normal writing, user data added with a preamble and a sync mark is written in the respective sectors 212A and 212B. Further, at this time, user data in the preceding sector 212A includes continuation identifying information.

Thereafter, the write/read controller 142 switches a reading mode to a normal mode (S42 and S43), and causes the magnetic head 23 to read the data from the target sector 212B (544). When a sync mark is read from the target sector 212B and the user data is read (YES at S45), a series of a reading process is complete. On the other hand, when the user data is not read even after overwrite (NO at S45), the write/read controller 142 performs a reassigning process, and registers the target sector 212B as an unavailable sector hereafter (S46).

In the reading process in the third embodiment, because data is continuously written in over the preceding sector 212A and the target sector 212B, when reading cannot be performed thereafter from the target sector 212B in the normal mode, reading using the sync mark 215A of the preceding sector 212A becomes possible in the tag diversion mode.

In other words, it is preferred that the magnetic head performs reading of data recorded on the magnetic disk and writing of data into the magnetic disk, and the controller causes the magnetic head to read the user data from the preceding sector, and when the user data recorded in the target sector is read in the tag diversion mode, causes the magnetic head to continuously overwrite the user data read from the preceding sector and the target sector in the preceding sector and the target sector, by adding thereto a start tag indicating a recording start position of the user data.

According to the above embodiments, the user data in the target sector is read based on the start tag of the preceding sector and the positional relationship between the sectors, in the tag diversion mode. Consequently, even when the start tag of the target sector cannot be read, the user data can be read.

In the tag diversion mode of the above embodiments, a sector arranged at a position to be read immediately before the target sector is designated as the preceding sector. However, the preceding sector in the tag diversion mode can be a sector to be read two or more sectors before the target sector, instead of the sector to be read immediately before the target sector.

Further, in the above embodiments, the sync mark indicating that the user data is read immediately thereafter is illustrated as the start tag. However, the start tag needs only to indicate the recording start position of the user data, and for example, the start tag can be recorded at a position away from the user data by a certain distance. In this case, in the normal mode, a time corresponding to the certain distance is set to the timer instead of 0, as a delay time.

While the above embodiments have explained a case of using a magnetic disk drive, the embodiments are not limited thereto. The embodiments are also applicable to a magnetic head, an optical head, a magnetic optical head, a disk medium, and a tape medium, so long as it is an information storage medium that reads data recorded on a medium by a head.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage device, comprising:
a head configured to read user data and a start tag indicating a recording start position of the user data in each sector recorded on a medium, the user data and the start tag being read in order of the start tag and the user data while the head relatively moving on a track of the medium; and
a controller configured to control the head to read a start tag recorded in a preceding sector arranged at a position to be read before a target sector with a movement of the medium, acquire information on a recording start position of a user data recorded in the target sector based on the start tag read by the head and a relative positional relation between the preceding sector and the target sector, and control the head to read the user data recorded in the target sector.

2. The information storage device of claim 1, wherein, when the head cannot read a start tag of the target sector with a movement of the medium, the controller controls the head to read the start tag recorded in the preceding sector arranged at the position to be read before the target sector with the movement of the medium, acquires information on the recording start position of the user data recorded in the target sector based on the start tag read by the head and the relative positional relation between the preceding sector and the target sector, and controls the head to read the user data recorded in the target sector.

3. The information storage device of claim 1, wherein the controller designates a sector arranged at a position to be read immediately before the target sector with a movement of the medium as the preceding sector.

4. The information storage device of claim 3, wherein
continuation identifying information is recorded in the each sector arranged on the medium, the continuation identifying information indicating that data is recorded continuously over the sector and a sector arranged at a position to be read before or subsequent to the sector with a movement of the medium, and
when continuation identifying information is recorded in the preceding and target sectors, the controller controls the head to read the start tag recorded in the preceding sector arranged at the position to be read before the target sector with the movement of the medium, acquires the information on the recording start position of the user data recorded in the target sector based on the start tag read by the head and the relative positional relation between the preceding sector and the target sector, and controls the head to read the user data recorded in the target sector.

5. The information storage device of claim 3, wherein
the head is configured to read data recorded on a medium and write data into the medium, and
when the controller controls the head to read user data from the preceding sector, controls the head to read the start tag recorded in the preceding sector arranged at the position to be read before the target sector with the movement of the medium, acquires the information on the recording start position of the user data recorded in the target sector based on the start tag read by the head and a relative positional relation between the preceding sector and the target sector, and controls the head to read the user data recorded in the target sector, the controller controls the head to continuously overwrite the user data read from the preceding sector and the user data read from the target sector by adding thereto a start tag indicating a recording start position of the user data.

6. A control circuit of an information storage device comprising a head configured to read user data and a start tag indicating a recording start position of the user data in each sector recorded on a medium, the user data and the start tag being read in order of the start tag and the user data while the head relatively moving on a track of the medium, the control circuit comprising a controller configured to control the head to read a start tag recorded in a preceding sector arranged at a position to be read before a target sector with a movement of the medium, acquire information on a recording start position of a user data recorded in the target sector based on the start tag read by the head and a relative positional relation between the preceding sector and the target sector, and control the head to read the user data recorded in the target sector.
